(19) United States
(12) Patent Application Publication
(10) Pub. No.: US 2007/0269248 A1
(43) Pub. Date: Nov. 22, 2007

(54) Word input keyboard

(76) Inventor: Lorraine Jeanette Markotic, Calgary (CA)

Correspondence Address: DIEDERIKS & WHITELAW, PLC, 12471 Dillingham Square, #301, Woodbridge, VA, 22192, US

(21) Appl. No.: 11/435,870

(22) Filed: May 18, 2006

(51) Int. Cl. G06F 3/023

(52) U.S. Cl. 400/472

(57) ABSTRACT

A substantially standard layout keyboard for text input, having a plurality of standard keys, in a substantially standard layout (e.g. QWERTY, DVORAK, etc.), the keyboard having a plurality of word fragments associated with a selected subset of the plurality of standard keys, and a word input key adapted to input one of the plurality of word fragments, wherein one of the plurality of word fragments is input by activating the word input key in conjunction with one of the plurality of standard keys. Preferably, the word input key is set in a space adjacent the space bar.

### FIELD OF THE INVENTION

The present invention relates generally to input devices. More particularly, the present invention relates to an efficient keyboard providing multiple character or word inputs.

### BACKGROUND OF THE INVENTION

Alternative keyboards having unique or alternative layouts, shapes, and options are available for computers today, but the standard “QWERTY” type keyboard based on Sholes' keyboard for manual typewriters of the 1800's remains widely accepted and almost universally used today.

While serving the purpose of physically separating the most frequently sequentially used keys to avoid mechanical interference or jamming of the levers used to strike the characters on manual typewriters beginning in the 1800's, the standard “QWERTY” type “separation” design presents challenges to users and inefficiencies that are no longer warranted.

Due to the almost universal acceptance and relatively high degree of standardization, mastering the “QWERTY” type keyboard is a basic requirement in today's business world. There have been a number of efforts to improve the QWERTY keyboard.

U.S. Pat. No. 6,712,534 issued to Patel teaches the addition of additional keys into the central region of what would otherwise generally be a standard QWERTY keyboard. The additional keys include word pairs (digraphs) or triplets (trigraphs), and are activated by pressing one of the additional keys or by pressing the shift or alt keys with one of the additional keys. The requirement that the keyboard have additional keys, placed in the central region created by separating or splitting a standard QWERTY keyboard, leads to yet another non-standard QWERTY keyboard that is unfamiliar and difficult for a user to learn.

“Typewriter Keyboard Addition Based on Word Input Concept” teaches a generally standard QWERTY keyboard, which is modified by replacing the left half of the space bar with word input keys, the word input keys each having one of the most frequently occurring words. Unfortunately, due to the limited space available on input devices (e.g. about one-third of the space bar), only a few word input keys can be added in this manner, resulting only in a minor addition to the QWERTY keyboard, and the modified layout requiring that the position(s) of the added word input keys be learned.

It is, therefore, desirable to provide a word input keyboard that avoids these limitations, and enhances rather than alters the widely accepted keyboard layout.

### SUMMARY OF THE INVENTION

It is an object of the present invention to obviate or mitigate at least one disadvantage of previous keyboards.

In one embodiment, the present invention is a keyboard with a substantially standardized layout for text input comprising a plurality of standard keys, in a substantially standard layout, the keyboard having a plurality of word fragments associated with a selected subset of the plurality of standard keys, a word input key adapted to input one of the plurality of word fragments, wherein one of the plurality of word fragments is input by activating the word input key in conjunction with one of the plurality of standard keys. Preferably, the word fragments are associated with the selected subset of the plurality of standard keys on a one to one basis.

The standard layout may preferably comprise a “QWERTY” layout, a “DVORAK” layout, or any other widely accepted or standardized layout. The word fragments may comprise trigraphs. The trigraphs preferably comprise “the” and “and”. Preferably, the trigraphs comprise composite trigraphs, a component of composite words. The composite trigraphs may comprise “any” or “ing”. Preferably, the trigraphs may comprise twenty-six (26) trigraphs commonly occurring in the English language.

The word fragments may comprise words. Preferably, the words may comprise four (4) letter words or five (5) letter words.

Preferably, the word fragment key is located adjacent the “space bar”. Preferably, the word fragment key and a “short space bar” together fit within the space of a standard “space bar”. Preferably, the word fragment key is located to the left of the “short space bar”.

Preferably, the word fragments are mapped as follows to the standard keys: which: Q; with: W; was: E; this: R; the: T; ent: Y; you: U; ing: I; other: O; their: P; and: A; some: S; from: D; for: F; that: G; have: H; www.: J; have: K; any: L; would: Z; are: X; .com: C; there: B; thing: B; tion: N; these: M.

In another aspect, the present invention is a substantially standard layout keyboard for text input, having a plurality of standard keys, in a substantially standard layout, the keyboard comprising a plurality of word fragments associated with a selected subset of the plurality of standard keys; a word input key adapted to input one of the plurality of word fragments; selection means for modifying at least one of the plurality of word fragments, wherein one of the plurality of word fragments is input by activating the word input in conjunction with one of the plurality of standard keys, and wherein at least one of the plurality of word fragments can be selected or modified with the selection means. Preferably, the substantially standard layout comprises a “QWERTY” layout or a “DVORAK” layout or some other widely accepted or standardized layout.

In another aspect, the present invention is a substantially standard layout keyboard for text input, having a plurality of standard keys, in a substantially standard layout, the keyboard comprising a plurality of word fragment keys, the word fragment keys grouped proximate the plurality of standard keys. Preferably, the word fragment keys are above, or to the left, or to the right, or in some combination of above, left and right. Preferably, the substantially standard layout comprises a “QWERTY” layout or a “DVORAK” layout or some other widely accepted or standardized layout.

Preferably, the standard keys are arranged generally on a first plane, the word fragment keys arranged in a second plane, the first and second plane at a relative angle. Preferably, the relative angle is an acute or obtuse angle. Alternatively, the relative angle is substantially 90 degrees.

Preferably, the standard layout keyboard is adapted for use with a computer with a keyboard portion and a display portion, wherein the display portion is substantially proximate the keyboard portion, wherein the keyboard portion forms the first plane and the display portion forms the second plane.

Preferably, the word fragment keys comprise keys having the word fragments: other; .com; www.; thing; these; there; they; you; are; some; could; tion; ent; their.

Preferably, the word fragment keys comprise keys having the word fragments: would; their; any; was; from; that; and; the; for; with; have; this; ing; which.

The above keyboard is preferably in the English, Chinese (traditional or simplified) or Hindi language.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a typical modern “QWERTY” style standard keyboard known in the art;

FIG. 2 is an embodiment of a keyboard of the present invention;

FIG. 3 is an embodiment of a keyboard of the present invention; and

FIG. 4 is an embodiment of a keyboard of the present invention.

### DETAILED DESCRIPTION

Generally, the present invention provides an apparatus for more efficient keyboard entry of words (or portions of words or word fragments) or text (or portions of text or text fragments) or symbols (or portions of symbols or symbol fragments), particularly helpful for two-finger or “hunt-and-peck” typists but also for two hand “touch” typists or one hand hunt-and-peck or one hand touch typists.

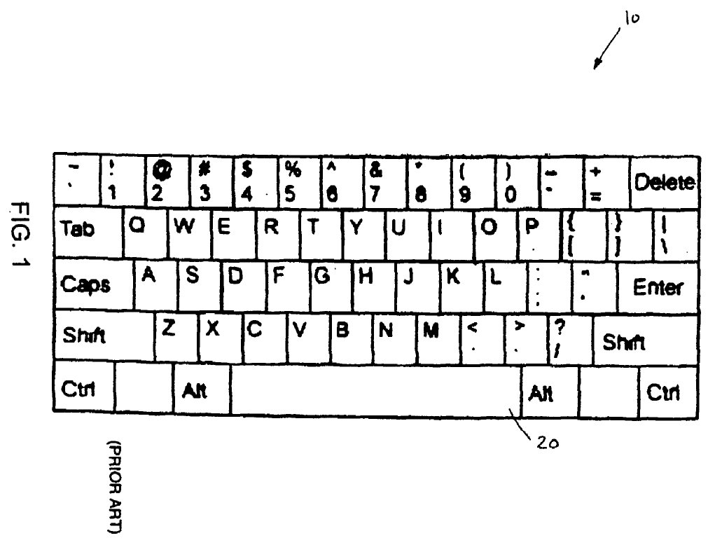

Referring to FIG. 1, one embodiment of a modern prior art keyboard 10 is shown in the “QWERTY” layout, that is, having the six top left keys “Q”, “W”, “E”, “R”, “T”, and “Y”. It has a space bar 20 located generally central to the layout of the keyboard 10, which is operable using any finger using the “hunt and peck” typing method or preferably with either thumb using the “touch” typing method. While not necessarily the most efficient layout, a standard layout keyboard is helpful to users, as the standardization provides ease of learning and use. The present invention is also applicable to new keyboard layouts, for example, if someone were to create an entirely new layout or a layout based on a slightly modified QWERTY or DVORAK layout.

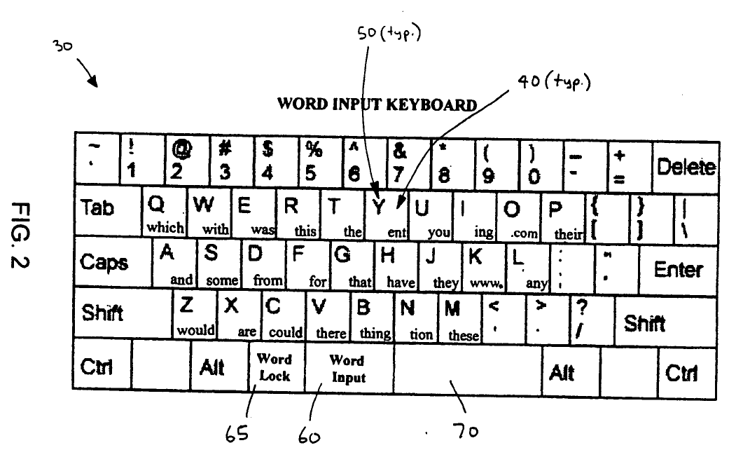

Referring to FIG. 2, an embodiment of the present invention is shown in a keyboard 30 having a number of word fragments 40 associated with a number of standard keys 50, for example word fragment 40 “ent” is associated with the standard key 50 “Y”, the word fragment 40 “tion” associated with the standard key 50 “N” etc. A word input key 60 is located adjacent a shortened space bar 70. The word input key 60 need not be labeled. The shortened space bar 70 and the word input key 60 fit within the space of the space bar 20 (FIG. 1). The word fragments 40, as claimed herein include words (or portions of words or word fragments, such as trigraphs) or text (or portions of text or text fragments) or symbols (or portions of symbols or symbol fragments or symbols (or portions of symbols or symbol fragments) or any other multi-character text or abbreviation or character input.

While the word input key 60 is depicted as a key on the keyboard 30, one ordinarily skilled in the art would recognize that other embodiments are available, for example, the word input key 60 could, for example, be in the form of a foot switch, a knee switch, or a paddle switch (e.g. proximate the keyboard 30 and operable by a slight movement of the user's hand.). In the case of a paddle, for example, a left paddle could be located proximate the keyboard generally to the left of the “A” key and raised above the keyboard 30, operable by slight movement of the operators hand. A second paddle could be similarly located on the rights side of the keyboard 30.

While the word fragments 40 are shown one to one on the standard keys 50 (e.g. the letter “Y” and the word fragment “ous”), alternatively, there may be a plurality of word fragments 40 associated with a standard key 50. With a plurality of word fragments 40, for example one or two or more could be on the top of a standard key and/or one or more could be on the front face of the standard key 50 (facing the user). To activate one of the word fragments 40, there may be a plurality of word input keys 60 (for example, if there are two word fragments 40 per standard key 50, then two word input keys 60 could be used.). Alternatively, a single word input key 60 could be used to cycle through the plurality of word fragments 40 on a standard key 50, e.g. by pressing the word input key 60 and pressing the standard key 50 would produce one of the plurality of word fragments 40 and pressing the standard key 50 again would produce the next of the plurality of word fragments 40 and so on. The plurality of word fragments 40 on a standard key 50 may be related or selected to be commonly occurring together, for example a single standard key 50 may have word fragments 40 “some” and “time”, which would provide the user to produce the phrase “some time” very efficiently.

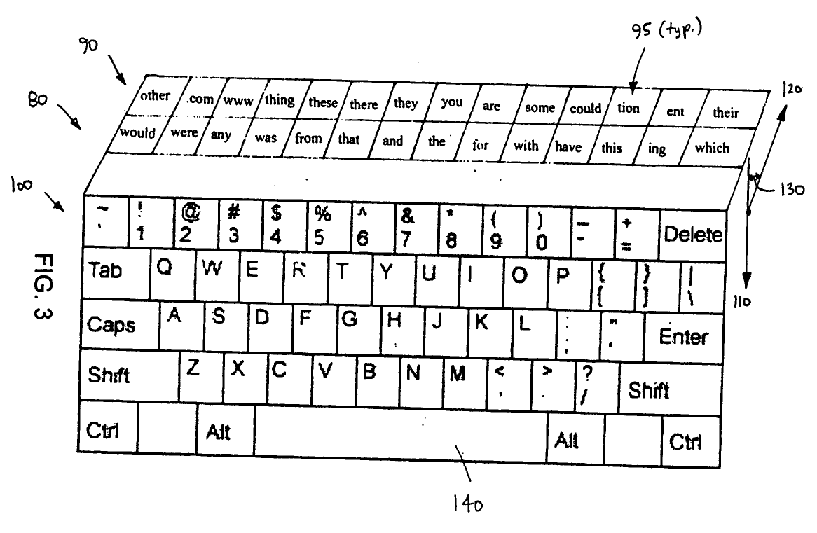

Referring to FIG. 3, an embodiment of the present invention is shown in a keyboard 80. A plurality of word fragment keys 90 are grouped proximate (for example, adjacent, beside, or above) a plurality of standard keys 100. The plurality of standard keys 100 are generally arranged on a first plane 110, which is generally horizontal. The plurality of word fragment keys 90 are generally arranged on a second plane 120, with a relative angle 130 formed between the first plane 110 and the second plane 120. The relative angle 130 may be an acute angle. Preferably, the relative angle 130 is substantially 90 degrees. As shown, the space bar 140 of this embodiment may be a conventional space bar, as the word fragment keys 90 are directly accessible without a need for a word input key.

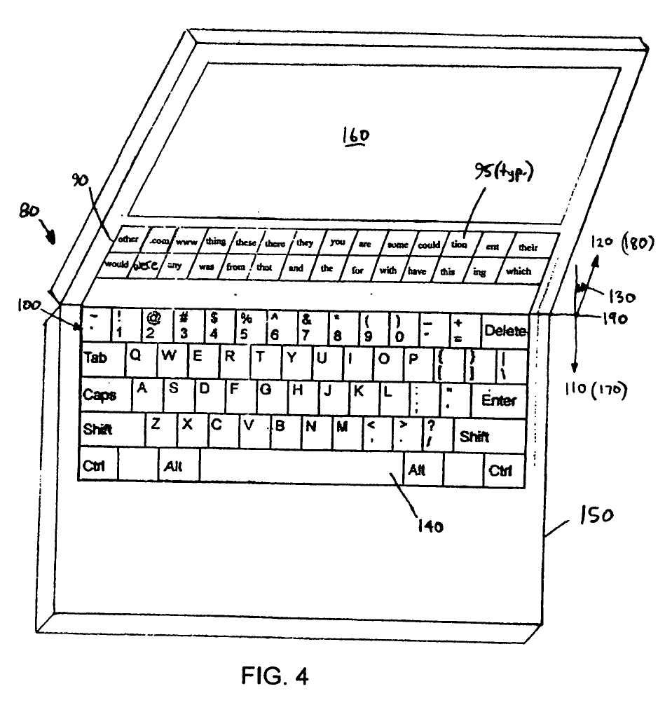

Referring to FIG. 4, an embodiment of the present invention is shown in the case of a computer 150 with a keyboard 80/display 160 combination, where the display is substantially proximate the keyboard, known by one ordinarily skilled in the art (e.g. a portable or “laptop” type computer having a keyboard portion 170 forming the first plane 110 and a display portion 180 forming the second plane 120, the display portion 180 pivotally with respect to the keyboard portion 120 about a pivot 190), the plurality of word fragment keys 90 may be located on the display portion 180, preferably reachable by a user with a minor extension of the user's digits and/or arm.

The plurality of word fragment keys 90 are preferably reachable by the user without the user having to move his or her hands too far off the plurality of standard keys, for example, when using the “touch” typing method.

One ordinarily skilled in the art would recognize that the benefits of the keyboard of FIG. 2 and keyboard of FIG. 3 or 4 may be combined to provide even greater access to word fragments.

Referring generally to FIG. 2, the keyboard 30 may include selection means (not shown) for modifying at least one of the word fragments 40. The selection means may include hardware or software mapping controls for example, so that the word fragment 40 associated with a standard key 50 may be selected or modified. For example, the word fragment 40 “ent” associated with the standard key 50 “Y” may be selected or modified such that a different word fragment 40 is associated with the standard key 50 “Y”, e.g., the word fragment 40 “ous” could be associated with the standard key 50 “Y”.

The marking for the word fragments 40 on the standard keys 50 may be labeled directly on the standard keys 50 (as shown), but alternatively the labeling or indications of which word fragment 40 is associated with which standard key 50 may be accomplished by one or more of several means known to one ordinarily skilled in the art, for example, by labeling with an adhesive sticker or overlay, by etching, by marking with a different color or colors, by on an on-screen keyboard or display, by a on-key indicator such as a light emitting diode (LED) display, or by a separate mapping indicator such as a template or summary sheet.

Referring generally to FIG. 3 or 4, a keyboard 80 may include selection means for modifying at least one of the word fragments 95 associated with the word fragment keys 90. The selection means could include hardware or software controls for example, so that the word fragment 95 associated with word fragment key 90 may be selected or modified. For example, the word fragment 95 “tion” associated with the word fragment key 90 may be selected or modified such that a different word fragment 95 is associated with the word fragment key 90 “tion”.

The keyboard 80 may also be selectively adapted to add a space character after a selected word fragment 50, for example by holding down the word input key 60 while pressing the standard key 40 “K” key to get the word fragment 50 “have” plus a space character. The selection of whether or not to add a space character could be made in hardware associated with the keyboard 80 or could be made in software associated with a general purpose or special purpose computer, associated with the keyboard 80.

In operation, referring to FIG. 2, the keyboard 30 is operated as a conventional QWERTY keyboard using the standard keys 40 and the shortened space bar 70. A selected word fragment 50 may be input by activating the word input key 60 followed by activating the standard key 40 associated with the selected word fragment 50, typically by holding down the word input key 60 while pressing the standard key 40 associated with the selected word fragment 50, for example by holding down the word input key 60 while pressing the standard key 40 “Y” key to get the word fragment 50 “ent” or by pressing the standard key 40 “Z” key to get the word fragment 50 “would”. A word lock key 65 may be used to selectively continuously activate the word input key 60, similar to a conventional “caps lock” key.

In operation, referring to FIG. 3 or 4, the keyboard 80 is operated as a conventional QWERTY keyboard using the standard keys 100 and the space bar 140. A selected word fragment 95 may be input by activating the associated word fragment key 90, typically by pressing the word fragment key 90 associated with the selected word fragment 95, for example by pressing the word fragment key 90 “tion” to get the word fragment 95 “tion”.

While preferably for general purpose computers of the types used in many homes, businesses, and schools, the present invention is also applicable to other devices, processors, machinery, operations, etc. utilizing text or word input. One ordinarily skilled in the art recognizes that electromechanical or other communications may be utilized to convert the mechanical activation of the keys into a signal or input useable by such computers, devices, processors, machinery, operations, etc.

While shown in the English or Latin style alphabet, the keyboard of the present invention is readily adaptable to other languages by one ordinarily skilled in the art. While the standard keys and the word fragments are shown to be letters of the English or Latin style alphabet, the keyboard of the present invention is readily adaptable by one ordinarily skilled in the art, to include symbols, representations, or characters of other languages.

While shown in the standard layout “QWERTY”, the present invention is applicable to other standard layout keyboards such as “DVORAK” or a brand new keyboard layout etc.

The above-described embodiments of the present invention are intended to be examples only. Alterations, modifications, and variations may be effected to the particular embodiments by those skilled in the art without departing from the scope of the invention, which is defined solely by the claims appended hereto.

What is claimed is:

1. A keyboard with a substantially standardized layout for text input, having a plurality of standard keys, in a substantially standard layout, the keyboard comprising:
i) a plurality of word fragments associated with a selected subset of the plurality of standard keys;
ii) a word input key adapted to signal input of one of the plurality of word fragments,
wherein one of the plurality of word fragments is input by activating the word input key in conjunction with one of the plurality of standard keys.

2. The keyboard of claim 1, the word fragments associated with the selected subset of the plurality of standard keys on a one to one basis.

3. The keyboard of claim 1, further comprising a text lock key, the text lock key adapted to toggle the word input key between an activated mode and an inactivated mode upon pressing the text lock key.

4. The keyboard of claim 1, the standard layout comprising a “QWERTY” layout.

5. The keyboard of claim 1, the standard layout comprising a “DVORAK” layout.

6. The keyboard of claim 1, wherein the word fragments comprise trigraphs.

7. The keyboard of claim 6, wherein the trigraphs comprise “the” or “and”.

8. The keyboard of claim 6, wherein the trigraphs comprise “any” or “ing”.

9. The keyboard of claim 6, wherein the trigraphs comprise twenty-six (26) frequently used English trigraphs.

10. The keyboard of claim 1, wherein the word fragments comprise composite fragments, a component of composite words.

11. The keyboard of claim 1, wherein the word fragments comprise words.

12. The keyboard of claim 11, wherein the words comprise four (4) letter words.

13. The keyboard of claim 11, wherein the words comprise five (5) letter words.

14. The keyboard of claim 1, wherein the word input key is located adjacent the space bar.

15. The keyboard of claim 14, wherein the word input key and a shortened space bar together fit within the space of a standard “space bar”.

16. The keyboard of claim 15, wherein the word input key is located to the left of the shortened space bar.

17. The keyboard of claim 1, wherein the word fragments are mapped as follows to the standard keys:
i) which: Q
ii) with: W
iii) was: E
iv) this: R
v) the: T
vi) ent: Y
vii) you: U
viii) ing: I
ix) .com: O
x) their: P
xi) and: A
xii) some: S
xiii) from: D
xiv) for: F
xv) that: G
xvi) have: H
xvii) they: J
xviii) www.: K
xix) any: L
xx) would: Z
xxi) are: X
xxii) could: C
xxiii) there: B
xxiv) thing: B
xxv) tion: N
xxvi) these: M

18. A keyboard with a substantially standardized layout for text input, having a plurality of standard keys, in a substantially standard layout, the keyboard comprising:
i) a plurality of word fragments associated with a selected subset of the plurality of standard keys;
ii) a word input key adapted to input one of the plurality of word fragments;
iii) selection means for modifying at least one of the plurality of word fragments,
wherein one of the plurality of word fragments is input by activating the word input key in conjunction with one of the plurality of standard keys, and wherein at least one of the plurality of word fragments can be selected or modified with the selection means.

19. The keyboard of claim 18, the word fragments associated with the selected subset of the plurality of standard keys on a one to one basis.

20. The keyboard of claim 18, further comprising a text lock key, the text lock key adapted to selectively toggle the word input key between an activated mode and an inactivated mode.

21. The keyboard of claim 16, wherein the substantially standard layout comprises a “QWERTY” layout or a “DVORAK” layout.

22. A substantially standard layout keyboard for text input, having a plurality of standard keys, in a substantially standard layout, the keyboard comprising a plurality of word fragment keys, the word fragment keys grouped proximate the plurality of standard keys.

23. The keyboard of claim 22, wherein the word fragment keys are positioned above the plurality of standard keys and/or to the left or to the right of the plurality of standard keys.

24. The keyboard of claim 18, wherein the substantially standard layout comprises a “QWERTY” layout or a “DVORAK” layout.

25. The keyboard of claim 22, wherein the standard keys arranged generally on a first plane, the word fragment keys arranged in a second plane, the first and second plane at a relative angle.

26. The keyboard of claim 25, wherein the relative angle is an acute angle.

27. The keyboard of claim 25, wherein the relative angle is an obtuse angle.

28. The keyboard of claim 25, wherein the relative angle is substantially 90 degrees.

29. The keyboard of claim 25, adapted for use with a computer with a keyboard portion and a display portion, wherein the display portion is substantially proximate the keyboard portion, wherein the keyboard portion forms the first plane and the display portion forms the second plane.

30. The keyboard of claim 22, the word fragment keys comprising keys having the word fragments:
i) other
ii) .com
iii) www.
iv) thing
v) these
vi) there
vii) they
viii) you
ix) are
x) some
xi) could
xii) tion
xiii) ent
xiv) their

31. The keyboard of claim 22, the word fragment keys comprising keys having the word fragments:
i) would
ii) were
iii) any
iv) was
v) from
vi) that
vii) and
viii) the
ix) for
x) with
xi) have
xii) this
xiii) ing
xiv) which

32. The keyboard of claim 1, adapted to automatically input a space character after the selected word fragment.

33. The keyboard of claim 1, wherein the standard keys and/or the word fragments are in the Chinese (traditional or simplified) language or Hindi language.
